(19) United States
(12) Patent Application Publication
(10) Pub. No.: US 2005/0055876 A1
(43) Pub. Date: Mar. 17, 2005

(54) Landscape border apparatus and method for installation

(76) Inventor: Herman Solis, Hollister, CA (US)

Correspondence Address: CENTRAL COAST PATENT AGENCY, PO BOX 187, AROMAS, CA, 95004, US

(21) Appl. No.: 10/934,205

(22) Filed: Sep. 3, 2004

Related U.S. Application Data
(60) Provisional application No. 60/500,605, filed on Sep. 5, 2003.

(51) Int. Cl. A01G 1/00

(52) U.S. Cl. 47/33

(57) ABSTRACT

A border system includes a simulated plastic board for making a garden border, the board having a generally rectangular cross section and a length, and comprising a series of holes formed through the simulated board in a vertical direction relative to installation orientation for the board, and a plurality of metal bars for driving through the holes and anchoring the board to ground. The system is characterized in that the diameter of the holes is controlled to provide a tight fit for metal bars to be used in anchoring the board.

### CROSS-REFERENCE TO RELATED DOCUMENTS

The present invention claims priority and was disclosed in provisional patent application Ser. No. 60/500,605 filed on Sep. 5, 2003. The disclosure of provisional application Ser. No. 60/500,605 is incorporated herein in its entirety by reference.

### FIELD OF THE INVENTION

The present invention is in the area of landscaping products and procedures, and pertains particularly to apparatus and methods for creating borders between lawn areas and non-lawn areas.

### BACKGROUND OF THE INVENTION

It is well-known in landscaping that physical borders are typically necessary between lawn areas and areas reserved for such as flowers and shrubs. In the landscaping arts trenches have been cut for such borders and treated wood boards have been placed in the trenches to top at grade level or somewhat above grade. These borders then prevent grass from encroaching in the non-lawn areas.

Relatively recently border materials have been developed comprising plastic moldings or extrusions treated to appear to be wooden. These materials, provided in cut or formed lengths are used very much as the wooden materials were used, except the plastic materials are lighter, easier to bend to curvatures, and far more resistant to deterioration.

There are some serious problems with the newly developed plastic border materials, usually called bend-a-boards. One is that these materials must be anchored securely to the earth to remain stable in use. The usual way of doing this is to attach plastic stakes 102 to the bend-a-boards 101 such as shown in FIGS. 1a and 1b. The stakes are typically of the same material as the bend-a-board itself, and are attached by drilling holes and driving screws through the stakes and into the boards. The stakes are not particularly strong, and in hard and/or rocky soil driving these stakes into the ground without damaging the stakes or the board or both is problematic. Then, without secure anchor, the boards themselves twist and otherwise alter in position and effect, due to changing conditions, such as summer heat and winter cold.

What is clearly needed is a better apparatus and technique for using plastic bend-a-boards as borders.

### SUMMARY OF THE INVENTION

In a preferred embodiment of the present invention a simulated plastic board is provided for making a garden border, the board having a generally rectangular cross section and a length, comprising a series of holes formed through the simulated board in a vertical direction relative to installation orientation for the board, characterized in that the diameter of the holes is controlled to provide a tight fit for metal bars to be used in anchoring the board.

In another embodiment of the invention a border system is provided, comprising a simulated plastic board for making a garden border, the board having a generally rectangular cross section and a length, and comprising a series of holes formed through the simulated board in a vertical direction relative to installation orientation for the board, and a plurality of metal bars for driving through the holes and anchoring the board to ground. The system is characterized in that the diameter of the holes is controlled to provide a tight fit for metal bars to be used in anchoring the board. In a preferred embodiment the bars are rebar, as used for reinforcing concrete.

In another aspect of the invention a method for installing a garden border is provided, comprising the steps of (a) channeling a trench at the location for the border, the trench having a width and length accommodating a simulated plastic board having a generally rectangular cross section and a length, the board comprising a series of holes formed through the board in a vertical direction relative to installation orientation for the board, the diameter of the holes controlled to provide a tight fit for metal bars used in anchoring; (b) placing the board in the trench, (c) anchoring the board in the trench by driving the metal bars part way through the holes and into ground; (d) raising the board to or above grade; and (e) driving the metal rods further to be flush with the top of the board, or below the top of the board.

In various embodiments as described in enabling detail below, for the first time a new border system makes installation easier and the finished installation more durable and stable.

### BRIEF DESCRIPTION OF THE DRAWING FIGURES

FIG. 1a is a plan view of a plastic bend-a-board in the prior art with stakes attached.

FIG. 1b is an elevation view of the board and stakes of FIG. 1a.

FIG. 1c shows two boards joined together by a miter joint in the prior art. FIG. 1d is a view of the joined boards of FIG. 1c from the opposite side from FIG. 1c.

FIG. 2a is a plan view of a bend-a-board assembly in an embodiment of the present invention, using metal rods.

FIG. 2b is an elevation view of the bend-a-board of FIG. 2a, with metal rods in place.

FIG. 2c is a view of two bend-a-boards using a stake.

FIG. 2d is a view of the boards of FIG. 2c from the side opposite.

### DESCRIPTION OF THE PREFERRED EMBODIMENTS

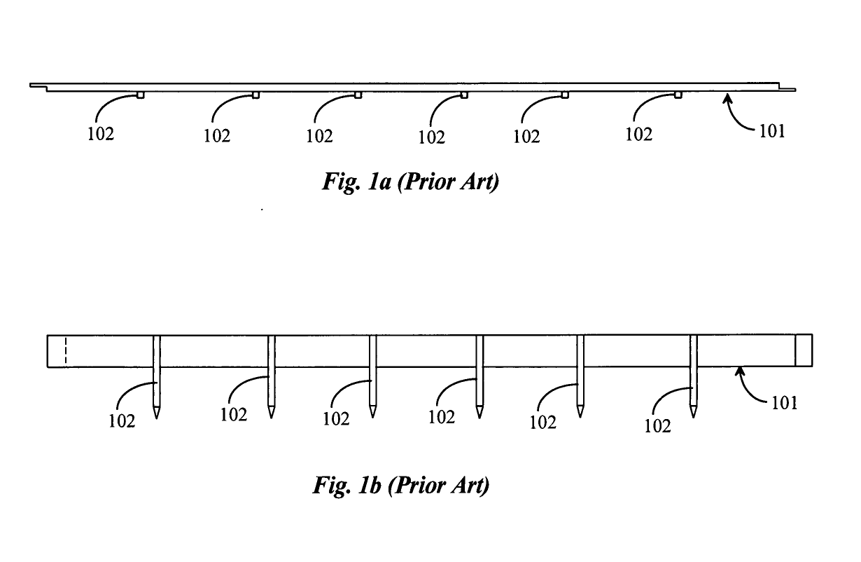

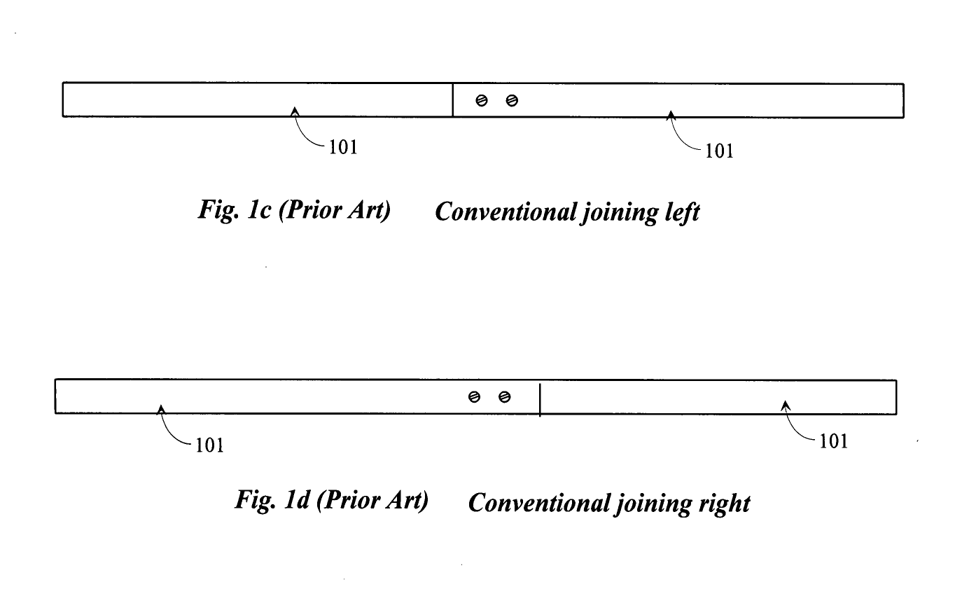

Using the conventional bend-a-board as shown in FIGS. 1a through 1d, and the usual method of installation, it is not possible to drive the stakes into soil that are very rocky or very high in clay content, and if by chance the stakes do go into these soils they shift to the left or to the right dramatically making the boarder very crooked. Even in sandy or loamy soils a border using plastic stakes will shift, lift and move due to expansion and contraction. Also, the plastic stakes are visible and this makes the boarder less appealing. Further, this installation process is very labor intensive. This method of border installation requires pre-grading, because after the plastic stakes are installed, adjusting the boarder up or down compromises the already low strength and stability of the plastic stakes.

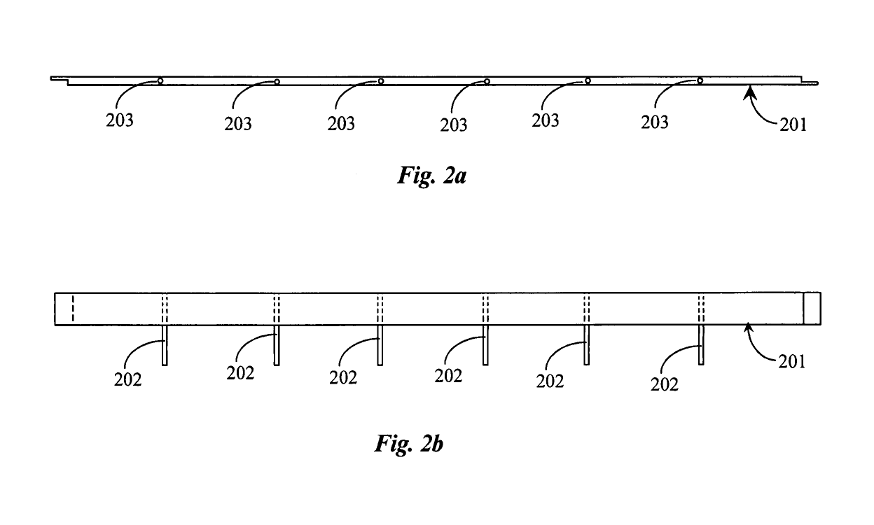

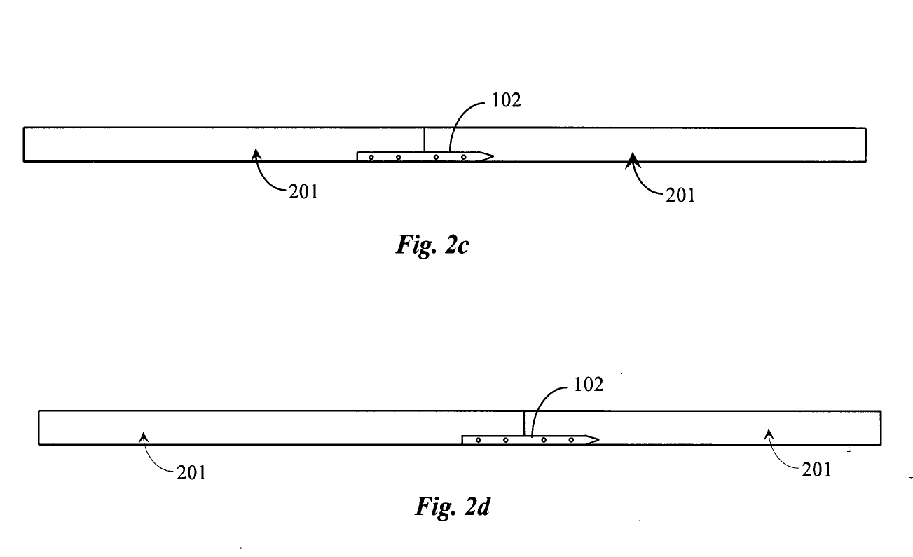

FIGS. 2a through 2d illustrate a bend-a-board assembly in an embodiment of the present invention, using metal rods. In these figures board 201 is much like the board 101 of FIG. 1a through 1d, except holes 203 of a specific size, and in some cases shape as well, are molded into or otherwise provided in the board length, the axes of the holes parallel to one another and directed in the vertical regarding the installation orientation of the board itself. Metal rods 202 in a preferred embodiment are cut lengths of reinforcement bar used for concrete installation, known as rebar in the construction arts.

Rebar is available in nominal ½ inch diameter and nominal 3/8 inch diameter, and holes for the bar pieces are drilled to about 1/32 to 1/8 inch less than the diameter of the rebar to be used, so that rebar driven into and through the holes makes a very tight fit. There is no need for pre-grading and one simply drives ½ or ¾ rebar part way into the board and then buries the board, usually in a preformed trench. Then, using a shovel or pry bar the board is raised to the proper grade or elevation.

Empirically tested, installation requires ⅓ or less of the time than is needed in practicing the prior art, and the rods do not bend when driving into rocky or clay soils as the original plastic stakes do. After installing the border using this new apparatus and method, the new border will not pop up, shift or move due to expansion and contraction. The soil type determines the length of the rods. Sandy or loamy soils require a longer length, about 16″. For rocky or clay soils 12″ rods are sufficient. One simply drills the appropriate holes 203 every three feet or so on center (actual spacing may vary), starting at the joint, ⅜ diameter hole for 1×4 boards and ½ diameter hole for 2×4 boards, minus the 1/32 to 1/8 inch less to securely hold the rebar.

Installation involves trenching the location where the border is to be installed, remembering no pre-grading is necessary. Then the board is placed place into the trench and the rebar pieces are driven ½ or ¾ of the way through the board. The board is then buried completely. One then lifts the board to the proper grade or elevation with a shovel, pry bar or other implement. Then the rebar is driven on through until the upper end of each is flush with the board or perhaps ⅛″ lower. The boards are fastened together in one embodiment using the original plastic stakes on both sides as show in FIGS. 1c and 1d, using 2″ galvanized deck screws on both sides.

In an alternative embodiment wooden boards can also be used with the hole diameter for the rebar controlled so the boards do not split with driving of the rebar.

It will be apparent to the skilled artisan that a number of alterations may be made in embodiments of the invention as described above without departing from the spirit and scope of the invention. Many sizes may be used, different materials are useful, hole spacing can be varied, and steps in installation may be changed somewhat as well.

1. A simulated plastic board for making a garden border, the board having a generally rectangular cross section and a length, comprising a series of holes formed through the simulated board in a vertical direction relative to installation orientation for the board, characterized in that the diameter of the holes is controlled to provide a tight fit for metal bars to be used in anchoring the board.

2. A border system, comprising:
a simulated plastic board for making a garden border, the board having a generally rectangular cross section and a length, and comprising a series of holes formed through the simulated board in a vertical direction relative to installation orientation for the board; and
a plurality of metal bars for driving through the holes and anchoring the board to ground;
characterized in that the diameter of the holes is controlled to provide a tight fit for metal bars to be used in anchoring the board.

3. The system of claim 2 wherein the bars comprise cut lengths of rebar material.

4. A method for installing a garden border, comprising the steps of:
(a) channeling a trench at the location for the border, the trench having a width and length accommodating a simulated plastic board having a generally rectangular cross section and a length, the board comprising a series of holes formed through the board in a vertical direction relative to installation orientation for the board, the diameter of the holes controlled to provide a tight fit for metal bars used in anchoring;
(b) placing the board in the trench;
(c) anchoring the board in the trench by driving the metal bars part way through the holes and into ground;
(d) raising the board to or above grade; and
(e) driving the metal rods further to be flush with the top of the board, or below the top of the board.
